(19) United States
(12) Patent Application Publication
(10) Pub. No.: US 2008/0028969 A1
(43) Pub. Date: Feb. 7, 2008

(54) Lubricant for an Image Forming Apparatus

(76) Inventors: Jean Marie Massie, Lexington, KY (US); Katherine Mary Mulloy, Lexington, KY (US); Jason Kyle Romain, Versailles, KY (US); Jerry Wayne Smith, Irvine, KY (US); Larry Earl Stahlman, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/461,802

(22) Filed: Aug. 2, 2006

(51) Int. Cl. B41M 7/00

(52) U.S. Cl. 101/494

(57) ABSTRACT

An image forming device comprising two components capable of relative movement and a lubricant disposed between such components. The lubricant may include a carrier medium capable of reducing friction between the components including boron nitride.

### 1. FIELD OF THE INVENTION

The present invention relates generally to the use of a lubricant in an image forming apparatus which may be used in connection with an image fixing device.

### 1. DESCRIPTION OF RELATED ART

An image forming apparatus, such as an electrophotographic device, ink printer, copier, fax, all-in-one device or multi-functional device may use developing agent such as toner or ink, which may be deposited on media to form an image. The developing agent, such as toner, may be fixed to the media using an image fixing device, which may apply heat and/or pressure to the toner. The image fixing device may include a heating device, such as a fuser. The image fixing device may also include a nip through which the media may be passed. The nip may be formed by the heating device and an opposing pressure roller or a back-up roller. A component, such as a belt or film, may be included in the fixing device, in proximity to the heating device to aid the transport of media through the fixing device nip.

### SUMMARY OF THE INVENTION

An image forming device comprising two components capable of relative movement and a lubricant disposed between such components. The lubricant includes a carrier medium and boron nitride (BN). The image forming device may include an image forming device cartridge and the two components may include a belt type fuser heater and a moving component such as a belt relative to such fuser. The boron nitride may include hexagonal boron nitride (HBN). The carrier medium may include polymeric resins having number average molecular weights of less than or equal to about 25,000.

### BRIEF DESCRIPTION OF THE DRAWINGS

The above-mentioned and other features and advantages of the present invention, and the manner of attaining them, will become more apparent and the invention will be better understood by reference to the following description of embodiments of the invention taken in conjunction with the accompanying drawings, wherein:

FIG. 1 schematically depicts an embodiment of an exemplary image fixing device.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. This invention may be embodied in many different forms and should not be construed as limited to the exemplary embodiments set forth herein.

An image forming apparatus may be understood herein to include any device which may provide an image to a given media. Such devices may therefore include, e.g., electrophotographic printers, inkjet printers, dye sublimation printers, thermal wax printers, electrophotographic copiers, electrophotographic multi-function devices, electrophotographic facsimile machines, or other types of image forming devices.

An image forming apparatus may therefore incorporate a fixing device, such as a fuser, for fixing toner or other image forming substances to media. The fixing device may include a heating device, for example, a belt fusing system or a hot roll system, which applies heat and/or pressure to the image fixing substance on the media. The heating device may include a heating element formed by a substrate with a resistive heating element on a surface thereof. The fixing device may also include a backup roll in cooperation with the heating device to form a nip through which the media passes.

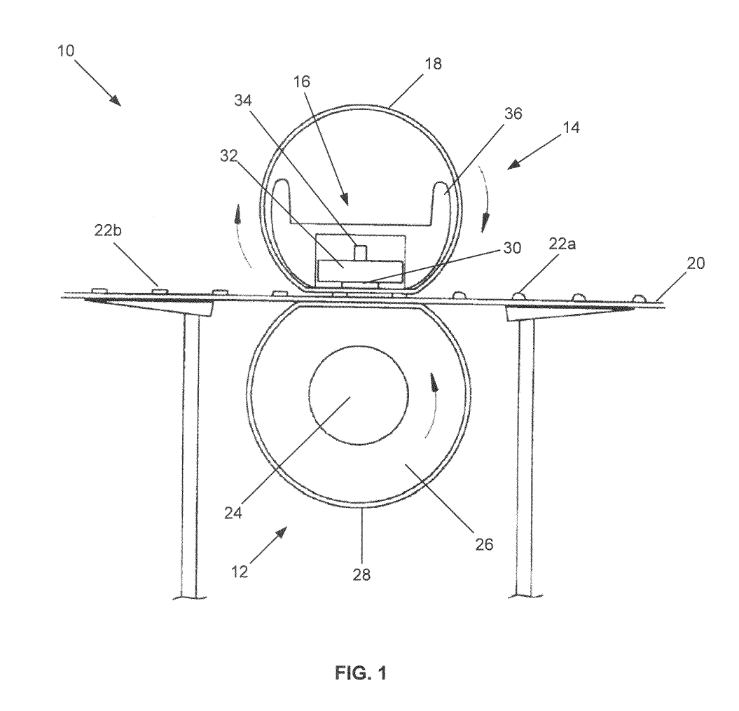

Referring to FIG. 1, an embodiment of an exemplary image fixing device 10 is shown. As noted above, other fixing devices are contemplated herein. The image fixing device 10 may generally include a pressure roller 12 and a heating device 14. The heating device 14 may include a heater 16 and a moving component 18, such as a belt or film, which may be at least partially disposed between the pressure roller 12 and the heater 16. A media 20 having developing agent or image forming substance, such as toner 22 deposited thereon may pass between the pressure roller 12 and the moving component 18. The toner may comprise conventional (milled) toner or chemically processed toner.

The media 20 may pass from an image developer (not shown) where the toner 22 may be deposited on the media 20. Prior to passing through the fixing device 10, the toner 22a may be loose on the media 20. The toner 22a and the media 20 may pass though the image fixing device 10, e.g. between the pressure roller 12 and the heating device 14. The toner 22a may be heated as the media 20 passes through the fixing device 10, fusing the toner 22b to the media 20.

The pressure roller 12 may have a variety of configurations. For example, as shown the pressure roller 12 may include a generally cylindrical central shaft portion 24. The shaft portion 24 may be formed from steel, aluminum, or other metallic or plastic materials. A covering layer 26 may be disposed over the shaft portion 24. The covering layer 26 may be a polymeric material, such as a rubber or elastic material. For example, the covering layer 26 may be formed from silicone rubber or other thermoplastic or thermoset materials. The covering layer 26 may be at least partially compliant allowing the pressure roller to be at least partially compressed against the heating device 14.

A sleeve 28 may be disposed over the covering layer 26. The sleeve 28 may include a low surface energy material, such as polytetrafluoroethylene, perfluoroalkoxy, fluorinated ethylene-propylene, fluoroelastomers and other fluoropolymers and combinations of fluoropolymers. The pressure roller 12 may be driven by a motor, which may have gear train, etc associated therewith, (not shown) coupled to the roller 12.

The heater 16 may include a number of elements. For example, the heater 16 may include one or more heat generating resistive elements 30. The resistive elements 30 may be supported by, or associated with a substrate 32. The substrate 32 may be an electrically insulating and thermally conducting member. For example, the substrate 32 may be a ceramic material, such as aluminum oxide. A temperature detector 34 may be mounted to detect the temperature of the resistive elements 30 or the substrate 32. The temperature detector 34 may communicate with a processor, e.g. enabling process control, etc. The resistive elements 30, substrate 32, and temperature detector 34 may be supported by a housing 36. Attention is therefore directed to U.S. Pat. No. 6,157,806 whose teachings are incorporated herein by reference.

The moving component 18, e.g., a belt, may be slidably disposed around the heater 16, e.g., to be rotatably slidable around the heater 16. The media 20 may driven by the pressure roller 12, which may be driven by a motor, to pass between the heating device 14 and the pressure roller 12. As the media 20 is driven between the pressure roller 12 and the heating device 14, the moving component 18 may slide around the heater 16 to allow for relative movement between the media 20 and the stationary heater 16, while providing a relatively matched surface velocity between media 20 and the heating device 14. In one embodiment, the pressure roller 12 may drive the media 20 between the pressure roller and the heating device 12 and may drive the moving component 18 around the heater 16. The relatively matched surface velocities may prevent, or at least reduce, slippage or sliding of the media across the heating device 14, which could disturb the toner pattern on the media 20.

The moving component 18 may be composed of a relatively high heat resistant and durable material, such as a polymeric material. Suitable polymeric materials may include, for example, polyimide, polyetherimide, polyetherketone, polyamide-imide, polyphenylene-sulfide, etc. The moving component 18 may be embodied as a flexible belt or tube around the heater 16. While not separately illustrated, the moving component 18 may include an outer layer exhibiting a relatively low surface energy, and may include a material such as polytetrafluoroethylene (PTFE), perfluoroalkoxytetrafluoroethylene (PFA) fluorinated ethylene-propylene (FEP), fluoroelastomers and other fluoropolymers and combinations of fluoropolymer and other materials. The relatively low surface energy outer layer may reduce the occurrence of adhesion between the moving component and the media or toner.

The interaction between the heater 16 and the moving component 18 may be desirably lubricated to increase the service life of the moving component 18. That is, the lubricant may provide relatively low frictional forces between the heater 16 and the moving component 18. The relatively low frictional forces may increase the useful service life of the motor, and gear train if any, associated with the pressure roller 12, which drives the media 20 between the pressure roller 12 and the heating device 14, and which may also drive the moving component 18 around the heater 16. The relatively low frictional forces between the moving component 18 and the heater 16 may also allow a smaller motor to adequately drive the pressure roller 12, media 20, and the moving component 18. Additionally, the relatively lower frictional forces between the moving component 18 and the heater 16 may also limit wear of the moving component 18, thereby extending the useful life of the image fixing device 10.

While the lubricant may extend the life of the drive motor and gear train, as well as reducing wear on the moving component 18, the lubricant may also desirably possess, to various degrees, relatively high temperature resistance, resistance to oil separation, resistance to chemical degradation, and resistance to excessive migration from between the moving component 18 and the heater 16. Desirably, the lubricant may also exhibit a minimal negative or harmful chemical interaction with components of the heater 16, such as the resistive element 30, substrate 32, housing 36, etc. Additionally, the lubricant may facilitate heat transfer from the heater 16 to the moving component 18.

Consistent with the foregoing, a suitable lubricant for lubricating the contact area between the moving component 18 and the heater 16 may be understood as a mixture of a thermally conductive particulate material dispersed within a carrier medium. The carrier medium may be understood as any material that may flow and/or lubricate within an image forming apparatus, which may be understood to include an image forming cartridge (e.g., printer cartridge such as a toner cartridge).

The carrier medium, either with or without the particulate material, may also be understood as any medium or medium/material combination which may reduce the frictional interaction between a moving component and a heater within an image forming apparatus. Such reduction in friction may include either the static and/or kinetic coefficient of friction that may of course exist between a component and a stationery surface. Static friction between two surfaces may be determined by the expression F_{static}=μₛN where μₛ is the coefficient of static friction and N is the normal force exerted on the surface and F_{static} is the force required to move a component. Kinetic friction may sometimes be referred to as sliding friction and may be determined by the relationship F_{kinetic}=μₖN where μₖ is the coefficient of kinetic friction and N is the normal force exerted on the surface and F_{kinetic} is the force necessary to slide a component across a given surface with a constant velocity. As used herein, particulate, or particulate material, may include any additive that remains solid when dispersed in a carrier medium, including powders, flakes, beads, fiber and mixtures thereof, etc. without limitation. The carrier medium and the thermally conductive filler may each be selected based on the above-discussed criteria, e.g., resistance to oil separation, resistance to chemical degradation, resistance to negative chemical interaction with components of the heating device 14, etc. Resistance to oil separation may therefore now be understood to be separation of the oil from the particulate material, which may occur under conditions of use within a given image forming apparatus and/or printer cartridge.

An embodiment of a lubricant consistent with the present disclosure may include boron nitride (BN) as an additive within the above described carrier medium. The boron nitride may specifically include hexagonal boron nitride (HBN), which may be produced by the nitridation or ammonlysis of boron trioxide and include a hexagonal (graphitic) crystal structure. Hexagonal boron nitride powder used herein may therefore include a total B+N content of greater than 95%, including all values and ranges therein. For example, HBN may include greater than 99% HBN along with relatively smaller amounts of calcium, carbon, iron, oxygen, chloride, aluminum, silicon, lead, arsenic, mercury, magnetic metal and/or moisture. Hexagonal boron nitride used herein may also have an average particle size of between 0.1-10 microns, including all values and increments therein. For example, HBN as employed herein may have an average particle size between about 0.3 to 0.7 microns.

The average surface area of the HBN particles may also be between about 5-25 m²/g, including all values and ranges therein. For example, the surface area may fall within the range of about 10-20 m²/g. It may therefore be understood that by selecting HBN with a consideration of either average particle size and/or surface area, it is possible to influence the interaction of the HBN with a given carrier medium (e.g. oil) and the effectiveness of the HBN as a lubricant within an image forming apparatus. It may therefore be appreciated that the HBN may be present in any given carrier medium in an amount of between about 0.50% by weight (wt.), including all values and increments therein. For example, the HBN may be present in an oil carrier medium at levels between 5-15% (wt.).

The addition of the boron nitride to an oil carrier medium may then also improve other associated properties of the oil, such as the lubricating properties of the oil as well as oil thermal conductivity, for example, on the general order of about 30 W/mK, although this value should not be construed as limiting. In addition, the boron nitride filler may be observed to be relatively immobile over its life within a given image forming apparatus. As the boron nitride filler has been observed as being capable of retaining oil, it may therefore be appreciated that the lubricating properties of a boron nitride/oil mixture herein may serve to reduce torque for a relatively longer period of time within a given image forming apparatus, as opposed to a simple (unfilled) oil system wherein the oil may tend to leak from its desired lubricating location. In one exemplary embodiment illustrating this particular feature it may now be appreciated that the retained lubricity of the oil boron nitride mixture allowed for a decrease in the driving force of the moving component to facilitate manual clearing of a paper jam, even when the lubricant was at room temperature. This decrease in the driving force then allowed a separate paper jam recovery system to be eliminated.

The oils herein may include any polymeric type material having a number average molecular weight (Mn) of less than or equal to about 25,000 (i.e., ≦25,000). The oils may therefore include fluorinated oil which may be understood as any polymeric resin that may contain “C—F” type bonds within its general structure. That is, there may be “C—F” type linkages on a main chain or side chain. The oil may be selected to have a minimal negative interaction with the various components of the image fixing device 10, and particularly with the components of the heating device 14. For example, the oils may be selected so that they do not chemically attack and, e.g., craze or promote stress cracking to a given heater assembly. It may therefore be appreciated that fluorinated oil may suitably be used in embodiments including aluminum oxide components, e.g., heater substrates. Such exemplary fluorinated oils may also have a number average molecular weight (Mn) less than or equal to about 25,000 including all values and ranges between about 1-25,000. For example, the fluorinated oils may have a Mn value of less than or equal to about 15,000. However, the suitability of any oil, fluorocarbon based or otherwise, may not be based solely on molecular weight.

Accordingly, various oils, in addition to fluorinated oils, may also be used in connection with, e.g. aluminum oxide heating components. Furthermore, various other oils, such as silicone based oils, etc., may suitably be used in other embodiments that do not rely upon aluminum oxide heating components, or in embodiments in which various components are otherwise protected against deleterious effects of such oils. An exemplary fluorinated oil includes perfluoropolyether (PFPE) type structures, which may be understood as including polymeric repeating units based upon the combination of a fully fluorinated methylene unit (—CF₂—) in combination with an ether type linkage (—O—). One suitable PFPE type oil is therefore DEMNUM™ S-200, available from Daikin Industries, Ltd. Such fluorinated oil is reportedly characterized as having an average Mn of about 8400, a glass transition temperature (Tg) of about −104° C. a viscosity at 200° C. of about 500 cSt, a viscosity index of about 210 and a pour point of about −53° C.

The foregoing description is provided to illustrate and explain the present disclosure. However, the description hereinabove should not be considered to limit the scope of the invention set forth in the claims appended here to.

What is claimed is:

1. An image forming device comprising two components capable of relative movement and a lubricant disposed between said device components, said lubricant comprising a carrier medium and boron nitride.

2. The image forming device of claim 1 wherein said carrier medium comprises a polymeric material with a number average molecular weight of ≦about 25,000.

3. The image forming device of claim 1 wherein said carrier medium comprises a polymeric fluorocarbon including C—F bonds.

4. The image forming device of claim 1 wherein said carrier medium comprises a perfluoropolyether compound.

5. The image forming device of claim 1 wherein said boron nitride comprises hexagonal boron nitride.

6. The image forming device of claim 1 wherein said boron nitride comprises hexagonal boron nitride having an average particle size of between about 0.1-10 microns.

7. The image forming device of claim 1 wherein said boron nitride is present in said carrier medium at about 0.1-50% (wt.).

8. The image forming device of claim 1 wherein one of said components comprises a heating device and one of said components is slidably disposed relative to said heater.

9. An image fixing device comprising two components capable of relative movement and a lubricant disposed between said fixing device components, said lubricant comprising a carrier medium and boron nitride.

10. The image fixing device of claim 9 wherein said carrier medium comprises a polymeric material with a number average molecular weight of ≦about 25,000.

11. The image fixing device of claim 9 wherein said carrier medium comprises a polymeric fluorocarbon including C—F bonds.

12. The image fixing device of claim 9 wherein said carrier medium comprises a perfluoropolyether compound.

13. The image fixing device of claim 9 wherein said boron nitride comprises hexagonal boron nitride.

14. The image fixing device of claim 9 wherein said boron nitride comprises hexagonal boron nitride having an average particle size of between about 0.1-10 microns.

15. The image fixing device of claim 9 wherein said boron nitride is present in said carrier medium at about 0.1-50% (wt.).

16. The image fixing device of claim 9 wherein one of said components comprises a heating device and one of said components is slidably disposed relative to said heater.

17. An image forming device cartridge comprising two components capable of relative movement and a lubricant disposed between said device components, said lubricant comprising a carrier medium and boron nitride.

18. The image forming device cartridge of claim 17 wherein said boron nitride comprises hexagonal boron nitride in said carrier medium at about 0.1-50% (wt.).

19. The image forming device cartridge of claim 17 wherein said components capable of relative movement define a static (μₛ) and kinetic (μₖ) coefficient of friction and said lubricant is capable of reducing either or both of μₛ or μₖ.

20. The image forming device cartridge of claim 17 wherein said cartridge includes an image fixing device and said components comprises a heating device and a belt with a surface capable of contacting said heating element and said lubricant is disposed between said surface and said heating element.
